(19) United States
(12) Patent Application Publication
(10) Pub. No.: US 2025/0018737 A1
(43) Pub. Date: Jan. 16, 2025

(54) RECORDING DEVICE

(71) Applicant: SEIKO EPSON CORPORATION, TOKYO (JP)

(72) Inventors: Tomoyuki HIGUCHI, SHIOJIRI-SHI (JP); Nobuhisa NOMOTO, MATSUMOTO-SHI (JP)

(21) Appl. No.: 18/770,747

(22) Filed: Jul. 12, 2024

(30) Foreign Application Priority Data
Jul. 12, 2023 (JP) 2023-114317

(51) Int. Cl. B41J 29/02; B41J 3/44; B41J 13/10; B41J 29/19; B41J 29/46; H04N 1/00; H04N 1/12

(52) U.S. Cl. CPC B41J 29/02; B41J 3/44; B41J 13/106; B41J 29/19; B41J 29/46; H04N 1/00795; H04N 1/1215; H04N 2201/0081

(57) ABSTRACT

The recording device 11 includes a device main body 12 having a placement tray 41 on which a medium 18 recorded by the recording section 30 is placed; a reading section 23 that is provided on the −Z direction side of the device main body 12 and that is configured to read a document; and a support section 70 that is provided between the device main body 12 and the reading section 23 in the Z-axis direction and that is configured to support the reading section 23, wherein the support section 70 includes a plurality of support pillars 71a, 71c provided on the outer side of the −X direction end of the placement tray 41 in the X-axis direction and a plurality of support pillars 71b and 71d provided on an outer side of the +X direction end of the placement tray 41 in the X-axis direction.

The present application is based on, and claims priority from JP Application Serial Number 2023-114317, filed Jul. 12, 2023, the disclosure of which is hereby incorporated by reference herein in its entirety.

### BACKGROUND

### 1. Technical Field

The present disclosure relates to a recording device.

### 2. Related Art

JP-A-2019-116050 discloses a recording device having a lower unit provided with a recording section for recording on a medium, and an upper unit provided with a reading unit for reading an image of a document placed on a document table and provided above the lower unit. It is disclosed that the lower unit has a pair of support sections that rise upward at both end portions in the device width direction and that support the upper unit at the end portions in the lengthwise direction. It is disclosed that the pair of support sections are provided so as to extend from the rear surface of the device to the center of the device in the device depth direction. A medium receiving tray that receives the medium discharged from the inside of the lower unit is provided on the upper portion of the lower unit at a position between the pair of support sections in the device width direction.

However, in the recording device disclosed in JP-A-2019-116050, in a case where a worker is working on the side of the recording device, there is a concern that it is difficult to see the medium discharged to the medium receiving tray from the side on which the support section is provided among the sides of the recording device.

### SUMMARY

A recording device includes a device main body having a placement tray on which a medium recorded by a recording section is placed; a reading section that is provided upward from the device main body and that is configured to read a document; and a support section that is provided between the device main body and the reading section in a height direction of the device main body and that is configured to support the reading section, wherein the support section includes a plurality of support pillars provided on an outer side of one end of the placement tray in the width direction of the device main body and a plurality of support pillars provided on an outer side of an other end of the placement tray in the width direction.

### BRIEF DESCRIPTION OF THE DRAWINGS

FIG. 1 is a perspective view showing an embodiment of a recording device.

FIG. 2 is a perspective view showing the recording device.

FIG. 3 is a schematic side view showing a main part of the recording device.

FIG. 4 is a schematic side view showing the main part of the recording device.

FIG. 5 is a schematic cross-sectional view showing the support section of the recording device.

FIG. 6A is an enlarged view of a portion 6A shown in FIG. 5.

FIG. 6B is an enlarged view of a portion 6B shown in FIG. 5.

FIG. 6C is an enlarged view of a portion 6C shown in FIG. 5.

FIG. 6D is an enlarged view of a portion 6D shown in FIG. 5.

FIG. 7A is a schematic cross-sectional view showing another embodiment of a support pillar constituting the support section.

FIG. 7B is a schematic cross-sectional view showing another embodiment of a support pillar constituting the support section.

FIG. 7C is a schematic cross-sectional view showing another embodiment of a support pillar constituting the support section.

FIG. 7D is a schematic cross-sectional view showing another embodiment of a support pillar constituting the support section.

### DESCRIPTION OF EMBODIMENTS

Hereinafter, the present disclosure will be described based on embodiments. In each drawing, the same members are denoted by the same reference symbols, and a duplicate description thereof will be omitted. Note that in the present specification, “the same”, “the identical”, and “at the same time” do not only refer to being exactly the same. For example, in the present specification, “the same”, “the identical”, and “at the same time” include the case of being the same in consideration of a measurement error.

For example, in the present specification, “the same”, “the identical”, and “at the same time” include the case where they are the same in consideration of manufacturing variations of members. For example, in the present specification, “the same”, “the identical”, and “at the same time” include the case where they are the same within a range that does not impair the function. Thus, for example, “both dimensions are the same” means that the dimensional difference between the two is within ±5 percent of one dimension, particularly desirably within ±3 percent, taking into account measurement errors and manufacturing variations of the member.

### 1. First Embodiment

A recording device 11 is, for example, an inkjet type printer capable of recording on a medium 18 such as a printing paper sheet.

Note that in each drawing, X, Y, and Z represent three spatial axes orthogonal to each other. In the present specification, directions along these axes are referred to as an X-axis direction, a Y-axis direction, and a Z-axis direction. In a case where a direction is specified, a positive direction is referred to as “+”, a negative direction is referred to as “−”, positive and negative signs are used together for direction notation, a direction in which an arrow in each drawing is directed is referred to as a +direction, and a direction opposite to the arrow is referred to as a-direction.

The Z-axis direction indicates the direction of gravity, a +Z direction indicates vertically downward, and a −Z direction indicates vertically upward. A plane including the X-axis and the Y-axis is explained as an X-Y plane, a plane including the X-axis and the Z-axis is explained as an X-Z plane, and a plane including the Y-axis and the Z-axis is explained as a Y-Z plane. The X-Y plane is a horizontal plane. Further, the three spatial axes of X, Y, and Z, which do not limit the positive direction and the negative direction, will be explained as the X-axis, the Y-axis, and the Z-axis.

The X-axis direction is a direction that intersects the transport direction of the medium 18 in the device main body 12, that is, a medium width direction, and is also a width direction of the recording device 11 and the device main body 12. The X-axis axial direction is a horizontal direction along a placement surface D, which is the horizontal plane on which the recording device 11 is placed. The +X direction is the left side and the −X direction is the right side as viewed from the operator positioned on the front surface side of the recording device 11. Note that in the present embodiment, the front surfaces of the recording device 11 and the device main body 12 are the surfaces on the side where a notification section 22 is provided.

The Y-axis direction is the depth direction of the recording device 11 and the device main body 12. The Y-axis direction is the horizontal direction along placement surface D, which is the horizontal plane on which the recording device 11 is placed. Among the Y-axis direction, the +Y direction is from the rear surface of the device main body 12 toward the front surface of the device main body 12, and the −Y direction is from the front surface of the device main body 12 toward the rear surface of the device main body 12.

The Z-axis direction is a normal direction with respect to the placement surface D and is the height direction of the device main body 12. In the following description, the +Z direction may be referred to as “downward”, and the −Z direction may be referred to as “upward”.

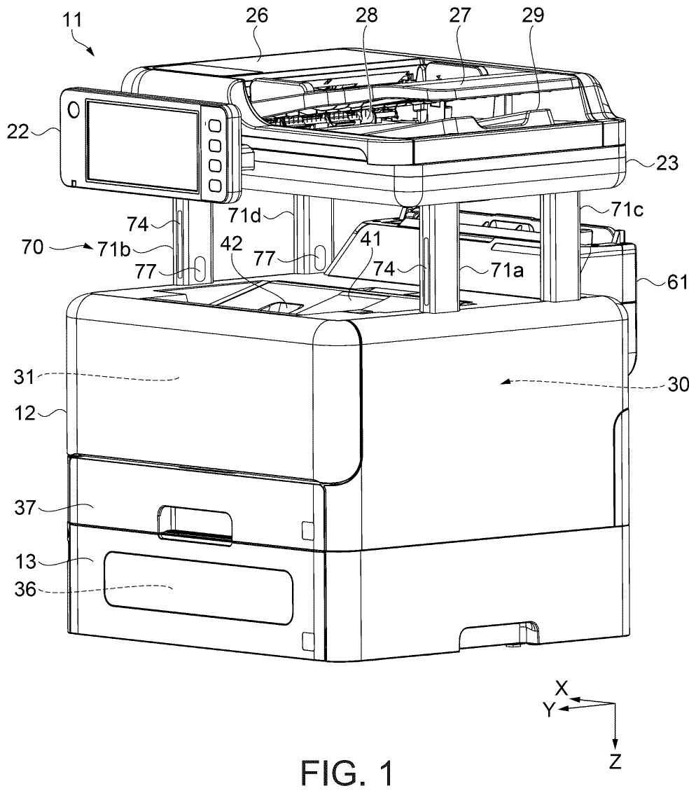

As shown in FIGS. 1 to 5, the recording device 11 includes the device main body 12, the notification section 22, and the reading section 23.

The notification section 22 has a monitor, a touch panel, and the like, and notifies the user by displaying a message. The notification section 22 may include a speaker that performs notification by emitting sound. The notification section 22 may perform the notification by outputting a sound or may perform the notification by issuing a warning sound or the like. The notification section 22 may include a light that performs notification by emitting light.

The reading section 23 includes a read sensor 24 that reads a document and a document cover 26. The reading section 23 is provided upward the device main body 12 on the −Z direction side in the Z-axis direction. The reading section 23 is provided at an interval from the device main body 12 in the Z-axis direction.

The document cover 26 is provided upward the reading section 23 on the −Z direction side. The document cover 26 is provided in the reading section 23 so as to be movable between a closed position (see FIG. 1) at which the −Z direction side of the reading section 23 is covered and an open position (not shown) at which the −Z direction side of the reading section 23 is opened. The document cover 26 includes a document supply tray 27, a document transport section 28, and a document discharge tray 29. The document is placed on the document supply tray 27. The document supply tray 27 is provided upward the document discharge tray 29 on the −Z direction side.

The document transport section 28 transports the document placed on the document supply tray 27 toward the reading section 23. The document transport section 28 transports the document, from which an image or the like has been read by the read sensor 24 of the reading section 23, toward the document discharge tray 29. A document whose image or the like has been read by reading section 23 is discharged to the document discharge tray 29.

The document transport section 28 of the present embodiment is provided on the +X direction side of the center of the reading section 23 in the X-axis direction. The reading section 23 is provided with the notification section 22. The notification section 22 is provided on the +Y direction side of the reading section 23 and on the +X direction side of the center of the reading section 23. Therefore, the centroid of the reading section 23 in the X-axis direction is positioned on the +X direction side from the center of the reading section 23.

The device main body 12 includes a first medium supply section 37, a first feeding section 38, a transport section 39, a medium support section 40, and a placement tray 41. The device main body 12 includes a second medium supply section 61, a second feeding section 64, a liquid accommodation body tray 36, a liquid accommodation body cover 13, a support section 70, and a control section 33.

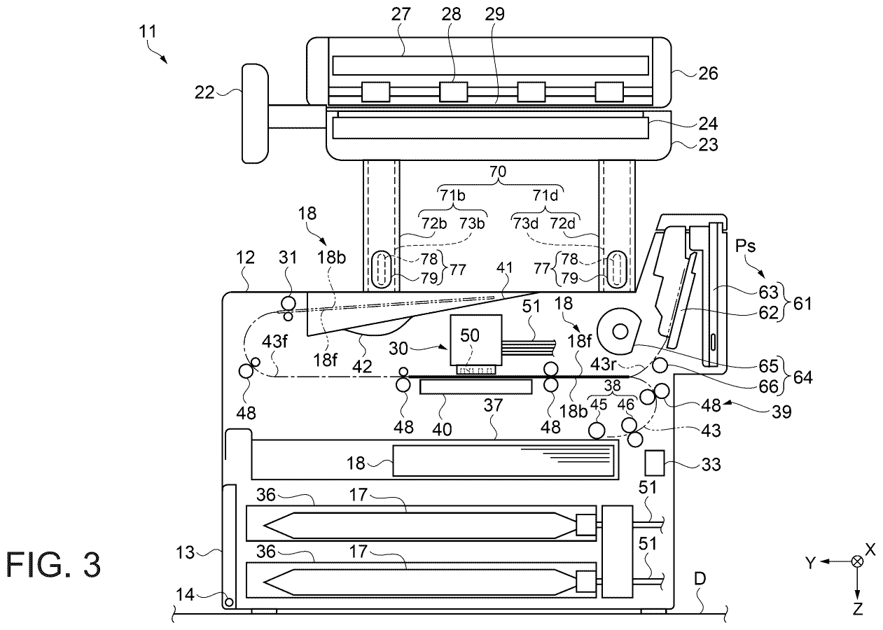

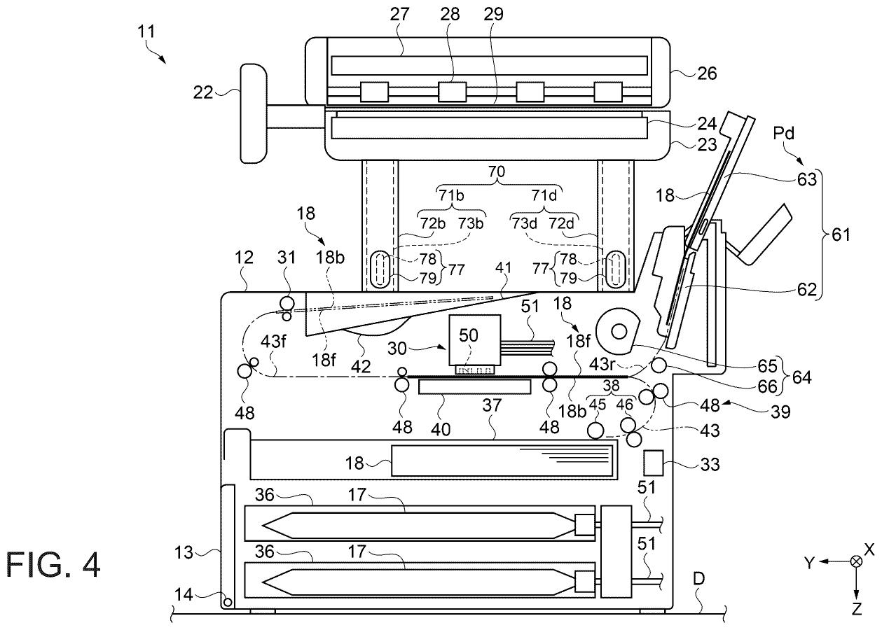

Note that in FIGS. 3 and 4, a transport path 43 and a feed path 43r through which the medium 18 is transported are indicated by two-dot chain lines, and a discharge path 43f is indicated by a one-dot chain line. The feed path 43r is a path that merges with the transport path 43 and connects the second medium supply section 61 and the transport path 43.

The first medium supply section 37 is capable of accommodating a plurality of medium 18 in a stacked state. The first medium supply section 37 is provided in the device main body 12 so as to be movable to a supply position (see FIG. 3) where the accommodated medium 18 can be sent out to the transport path 43 and a set position (not shown) on the +Y direction side of the supply position. The set position of the first medium supply section 37 is a position at which the medium 18 can be set in the first medium supply section 37.

The first feeding section 38 includes a pickup roller 45 and a separation roller pair 46. The pickup roller 45 rotates in a state of being in contact with the medium 18 accommodated in the first medium supply section 37, thereby sending the medium 18 located at the most upward position to the separation roller pair 46. The separation roller pair 46 separates the medium 18 one sheet at a time by pressing against the second and subsequent medium 18 from the top. The first feeding section 38 feeds the medium 18 accommodated in the first medium supply section 37 to the transport path 43 one sheet at a time.

The transport section 39 transports the medium 18 along the transport path 43. The transport section 39 includes a plurality of transport roller pairs 48 provided along the transport path 43. The transport roller pairs 48 transport the medium 18 by rotating in a state of sandwiching the medium 18.

The medium support section 40 is provided at a position facing a recording section 30 with the transport path 43 interposed therebetween. The medium support section 40 supports at least a portion of the medium 18 on which recording is to be performed.

The recording section 30 has a plurality of nozzles 50 capable of ejecting liquid. The recording section 30 ejects ink, which is an example of a liquid, to perform recording on a recording surface 18f of the medium 18. The recording surface 18f is a surface facing the nozzles 50 and opposite to a rear surface 18b contacting the medium support section 40.

A discharge section 31 discharges the medium 18 recorded by the recording section 30 to the placement tray 41. The discharge section 31 discharges the medium 18 with the recording surface 18f facing downward. The discharge section 31 discharges the medium 18 in a so-called face-down manner. The discharge section 31 is provided between the recording section 30 and the reading section 23 in the Z-axis direction. The discharge section 31 is, for example, a pair of discharge rollers that discharge the medium 18.

The placement tray 41 is provided on an upper surface, which is a surface in the −Z direction, of the device main body 12. The placement tray 41 is provided on the −Y direction side of the discharge section 31. The medium 18 discharged by the discharge section 31 is placed on the placement tray 41. The medium 18 on which recording is performed by the recording section 30 is transported toward the placement tray 41 from the +Y direction side of the device main body 12 in the Y-axis direction and is thereby placed on the placement tray 41. The placement tray 41 is positioned on the −Y direction side of the notification section 22 in the Y-axis direction. The placement tray 41 of the present embodiment is black.

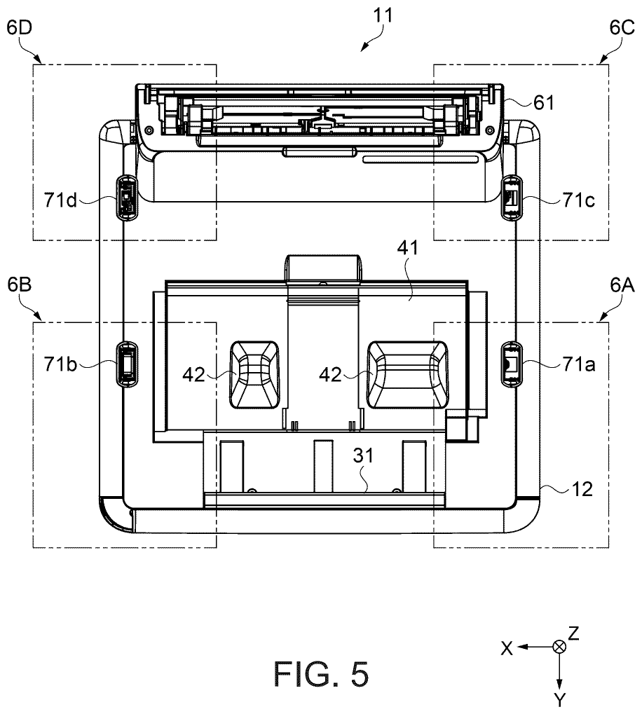

The placement surface of the placement tray 41 on which the medium 18 is placed is an inclined surface of which the position becomes the Z-axis direction in the −Z direction toward the −Y direction. The placement surface of the placement tray 41 is provided with a pair of recesses 42 (see FIG. 3). The pair of recesses 42, in the Y-axis direction, are provided on the +Y direction side from the center of the placement surface. The pair of recesses 42 are provided, with respect to the X-axis direction, at a position on the +X direction side from the center of the placement surface and at a position on the-X direction side from the center of the placement surface (see FIG. 5). The user may grip the medium 18 placed on the placement tray 41 by inserting a hand into the recess 42.

The second medium supply section 61 is provided on the rear surface side among the device main body 12, which is the −Y direction side from the recording section 30 in the device main body 12. The second medium supply section 61 includes a support body 62 and an auxiliary support body 63, that support the medium 18. The auxiliary support body 63 is provided in the device main body 12 so as to be movable between the stored position Ps shown in FIG. 3 and the deployed position Pd shown in FIG. 4. In the deployed position Pd, the auxiliary support body 63 supports the medium 18 to be placed by the user together with the support body 62.

As shown in FIGS. 3 and 4, the second feeding section 64 is provided on the rear surface side among the device main body 12, which is the −Y direction side of the recording section 30 in the device main body 12. The second feeding section 64 includes feed rollers 65 and 66. The second feeding section 64 transports the medium 18 (see FIG. 4) placed on the second medium supply section 61 by the user toward the medium support section 40 and the recording section 30 along the feed path 43r by the feed rollers 65 and 66.

The liquid accommodation body tray 36 accommodates a liquid accommodation body 17 that accommodates the ink to be ejected by the recording section 30. The liquid accommodation body tray 36 is provided in the device main body 12 so as to be movable to a supply position (see FIG. 3) where the +Z direction side of the first medium supply section 37 and an attachment/detachment position (not shown) which is the +Y direction side of the supply position. The supply position of the liquid accommodation body tray 36 is a position at which the ink in the liquid accommodation body 17 can be supplied to the recording section 30 by the liquid accommodation body 17 accommodated in the liquid accommodation body tray 36 and the recording section 30 being connected by a supply tube 51. The attaching/detaching position of the liquid accommodation body tray 36 is a position at which the liquid accommodation body 17 can be attached to and detached from the liquid accommodation body tray 36.

The recording device 11 of the present embodiment is provided with four liquid accommodation body trays 36 so as to be able to individually accommodate four liquid accommodation bodies 17. Four liquid accommodation body trays 36 are disposed such that two sets of two liquid accommodation body trays 36 arranged in the X-axis direction are provided in the Z-axis direction.

The liquid accommodation body cover 13 is provided on the device main body 12 so as to be openable and closable with a rotation shaft 14 as a rotation center. The liquid accommodation body cover 13 is movable between a closed position at which it covers the +Y direction side of the liquid accommodation body tray 36 that is in the supply position and an open position at which it is positioned on the +Z direction side of the liquid accommodation body tray 36. When the liquid accommodation body cover 13 is in the open position, the liquid accommodation body tray 36 is movable between the supply position and the attachment/detachment position.

The support section 70 supports the reading section 23. As shown in FIGS. 1 to 4, the support section 70 is provided between the device main body 12 and the reading section 23 in the Z-axis direction. The support section 70 has a plurality of support pillars 71a, 71b, 71c, and 71d. The support section 70 includes the plurality of support pillars 71a and 71c provided, with respect to the X-axis direction, on the outer side of the end of the placement tray 41 in the −X direction, and with an interval therebetween in the Y-axis direction, which intersects the X-axis direction. The support section 70 includes the plurality of support pillars 71b and 71d provided, with respect to the X-axis direction, on the outer side of the end of the placement tray 41 in the +X direction, and with an interval therebetween in the Y-axis direction. The end of the placement tray 41 in the −X direction is an example of one end of the placement tray 41. The end of the placement tray 41 in the +X direction is an example of an other end of the placement tray 41.

The recording device 11 of the present embodiment is placed on the placement surface D such as a desk so as to be usable by a plurality of users. For this reason, in addition to the user who is on the +Y direction side of the recording device 11, there are cases where users are on the +X direction side, the −X direction side, and the −Y direction side of the recording device 11. In such cases, for example, it is desirable that the medium 18 placed on the placement tray 41 is easily seen from the +X direction side, the −X direction side, and the −Y direction side of the recording device 11 in addition to the +Y direction side of the recording device 11.

In this regard, in the present embodiment, the user can visually check the medium 18 placed on the placement tray 41 from the +Y direction side of the recording device 11 through the interval between the support pillar 71a and support pillar 71b. The user can visually check the medium 18 placed on the placement tray 41 from the +X direction side of the recording device 11 through the interval between the support pillar 71b and support pillar 71d. The user can visually check the medium 18 placed on the placement tray 41 from the −X direction side of the recording device 11 through the interval between the support pillar 71a and support pillar 71c. The medium 18 placed on the placement tray 41 can be visually checked by the user from the −Y direction side of the recording device 11 through the interval between the support pillar 71c and the support pillar 71d.

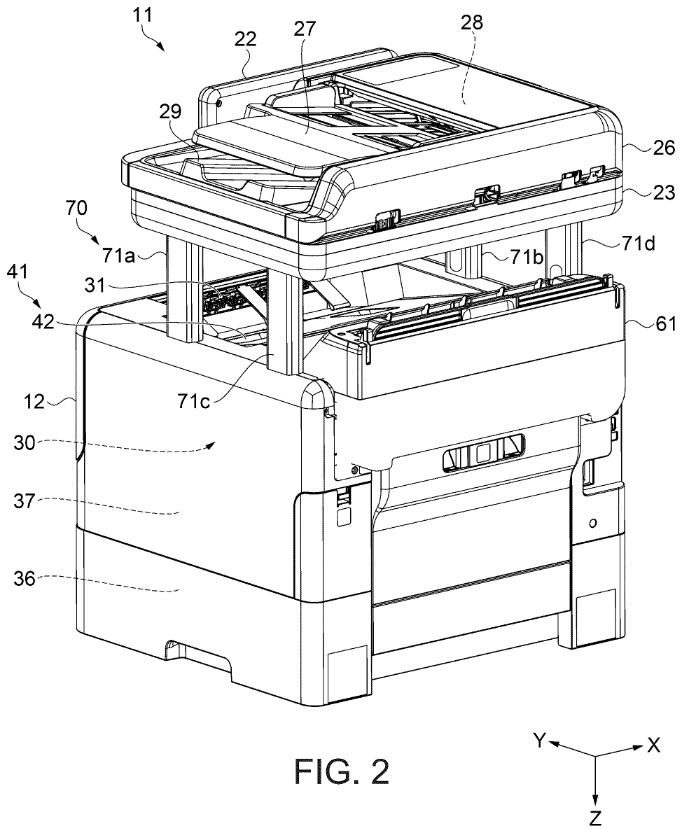

As shown in FIGS. 1 and 2, the support pillar 71a supports a position that among the lower surface, which is the surface in the +Z direction of the reading section 23, is closer to the end portion in the−X direction than the center and that is on the +Y direction side than the center. The support pillar 71b supports a position among the lower surface of the reading section 23 that is closer to the end portion in the +X direction than the center and that is on the +Y direction side from the center. The support pillar 71c supports a position among the lower surface of the reading section 23 that is closer to the end portion in the−X direction than the center and that is on the −Y direction side from the center. The support pillar 71d supports a position among the lower surface of the reading section 23 that is closer to the end portion on the +X direction than the center and that is on the −Y direction side from the center.

As shown in FIG. 5, the support pillars 71a and 71b are provided at the same position in the Y-axis direction. The support pillars 71a and 71b are provided on the +Y direction side with respect to the center of the device main body 12. The support pillars 71a and 71b are provided on the −Y direction side from the end of the placement tray 41 in the +Y direction. The support pillars 71a and 71b are provided on the −Y direction side with respect to the +Y direction end of the recess 42. The support pillars 71a and 71b are provided at positions overlapping the recess 42 in the Y-axis direction.

The support pillars 71c and 71d are provided at the same position in the Y-axis direction. The support pillars 71c and 71d are provided on the −Y direction side with respect to the center of the device main body 12. The support pillars 71c and 71d are provided on the −Y direction side from the end of the placement tray 41 in the −Y direction.

As shown in FIG. 5, the support pillars 71a, 71b, 71c, and 71d included in the support section 70 of the present embodiment have the same outer shape as viewed from a direction along the Z-axis direction. That is, the support pillars 71a, 71b, 71c, and 71d have the same thickness.

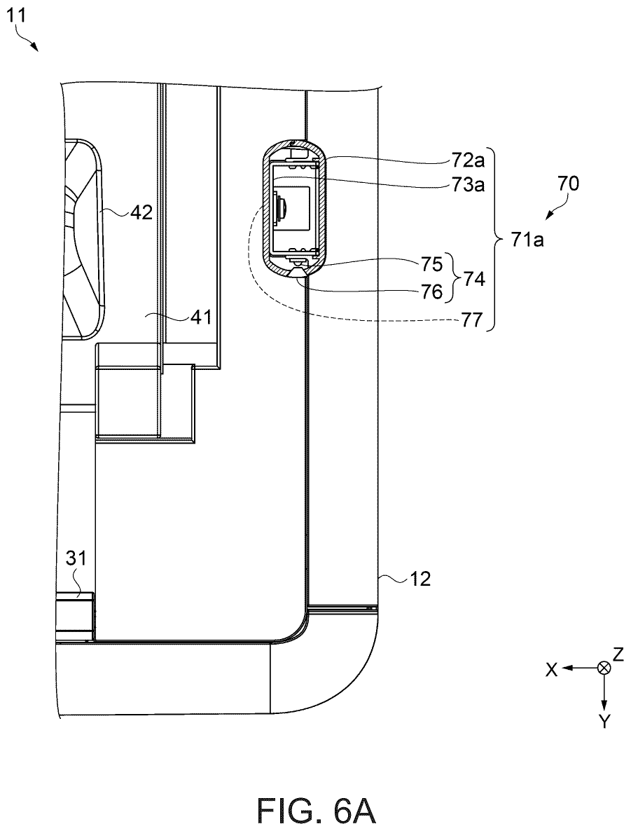

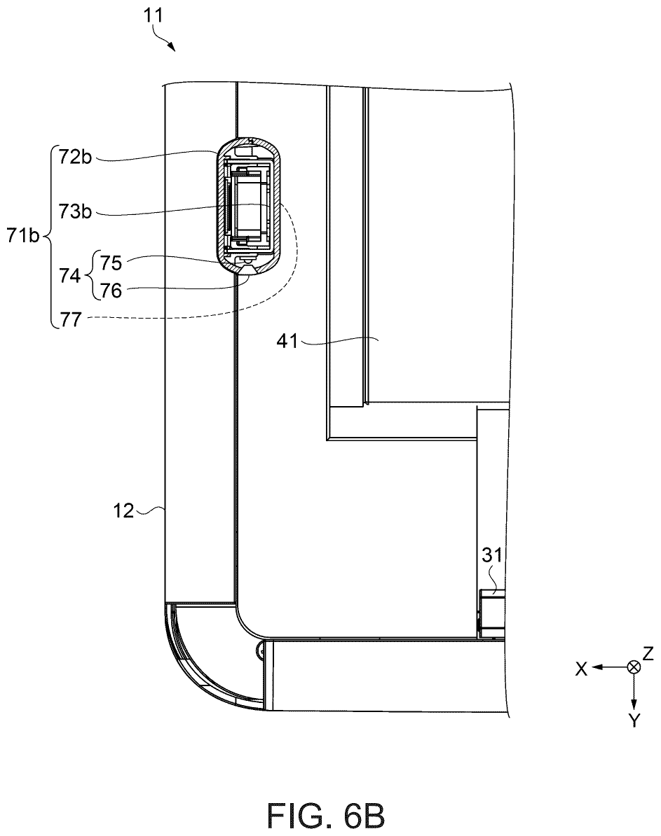

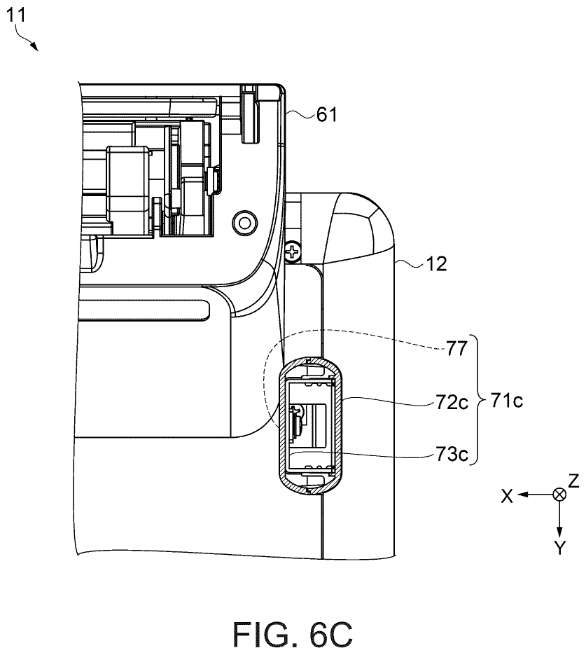

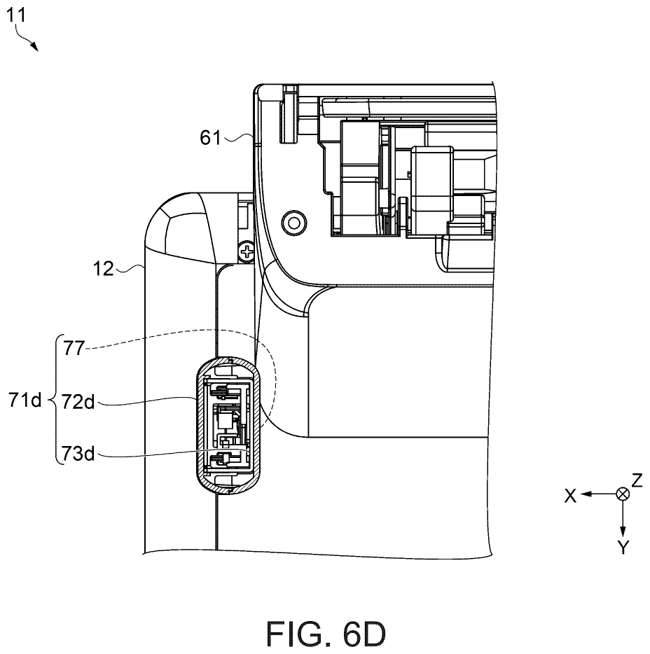

As shown in FIG. 6A, the support pillar 71a includes an inner member 73a and an outer member 72a provided on the outer side of the inner member 73a. As shown in FIG. 6B, the support pillar 71b includes an inner member 73b and an outer member 72b provided on the outer side of the inner member 73b. As shown in FIG. 6C, the support pillar 71c includes an inner member 73c and an outer member 72c provided on the outer side of the inner member 73c. As shown in FIG. 6D, the support pillar 71d includes an inner member 73d and an outer member 72d provided on the outer side of the inner member 73d.

The inner members 73a, 73b, 73c, and 73d extend in the Z-axis direction, and their end portions in the +Z direction are fixed to a frame (not shown) of the device main body 12, and their end portions in the −Z direction are fixed to a frame (not shown) of the reading section 23. The inner members 73a, 73b, 73c, and 73d have a cross-sectional shape of the letter U as viewed from the direction along the Z-axis direction. The inner members 73a, 73b, 73c, and 73d are formed, for example, by performing bending or the like on a steel plate such as a galvanized steel plate.

The outer members 72a, 72b, 72c, and 72d extend in the Z-axis direction and have an oval outer shape that is elongated in the Y-axis direction as viewed from the direction along the Z-axis direction. The outer members 72a, 72b, 72c, and 72d are formed by, for example, injection molding a resin material. The outer members 72a, 72b, 72c, and 72d may be formed of two members. Note that the outer members 72a, 72b, 72c, and 72d of the present embodiment are white. Therefore, the support pillars 71a, 71b, 71c, and 71d of the present embodiment are white.

The outer shape of each of the outer members 72a, 72b, 72c, and 72d of the present embodiment as viewed from the direction along the Z-axis direction has a shape in which two arcs of equal radius are connected along two straight lines, that is, a so-called track shape. The outer shape of the outer members 72a, 72b, 72c, and 72d defines the profile of the support pillars 71a, 71b, 71c, and 71d. In this case, the outer side surface on the +Y direction side and the outer side surface on the −Y direction side of the support pillars 71a, 71b, 71c, and 71d correspond to the two arcs of the track shape. The outer side surfaces on the +X direction side and the outer side surfaces on the −X direction side of the support pillars 71a, 71b, 71c, and 71d correspond to the two straight lines.

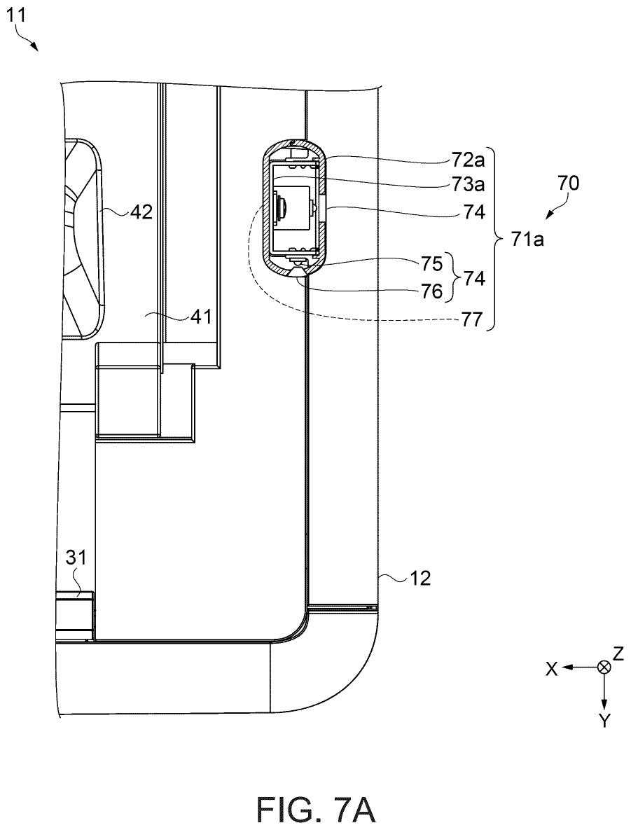

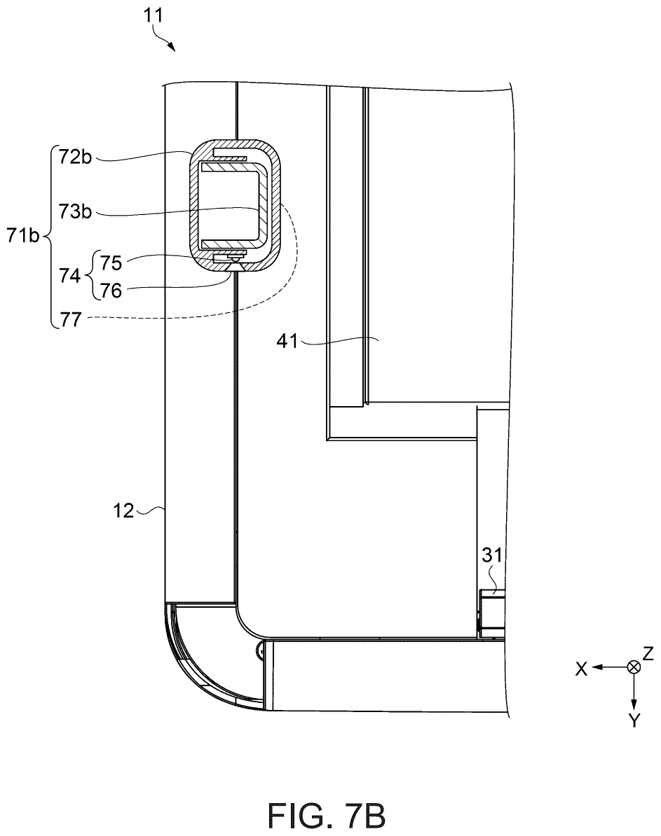

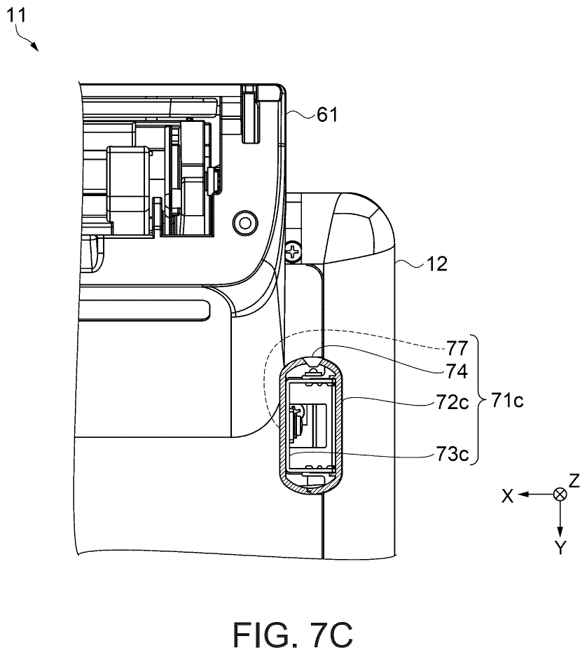

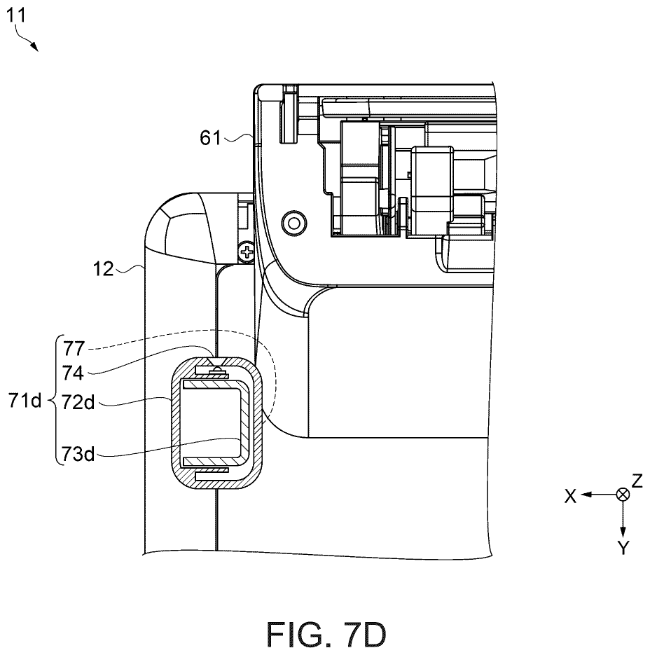

Note that the outer shape of the support pillars 71a, 71b, 71c, and 71d as viewed from the direction along the Z-axis direction may not be the track shape and may be an oval shape elongated in the Y-axis direction as long as the outer shape is a rounded shape. Alternatively, the outer shape of the support pillars 71a, 71b, 71c, and 71d as viewed from the direction along the Z-axis direction may be an oval shape elongated in the X-axis direction or may be a regular circle. The outer shape of the support pillars 71a, 71b, 71c, and 71d as viewed from the direction along the Z-axis direction may be a polygon with rounded corners, such as a quadrilateral, as in support pillars 71b and 71d shown in FIGS. 7B and 7D.

In other words, the outer side surface on the +Y direction side and the outer side surface on the −Y direction side of the support pillars 71a, 71b, 71c, and 71d have a rounded outer shape as viewed from the direction along the Z-axis direction. For example, it is assumed that the user takes out the medium 18 placed on the placement tray 41 from the +Y direction side of the support pillars 71a and 71b. In this case, there is a possibility that the hand of the user comes into contact with the outer side surfaces of the support pillar 71a and support pillar 71b on the +Y direction side. Therefore, a rounded shape is desirable for the outer side surface of the +Y direction side of at least the support pillars 71a and 71b. Note that the +Y direction side is an example of the front surface side of the device main body 12, and the −Y direction side is an example of the rear surface side of the device main body 12.

The support pillars 71a and 71b are provided with a light emitting section 74 for notification by emitting light. As shown in FIG. 1, the light emitting section 74 is provided on the side surface of the +Y direction side of the support pillars 71a and 71b, so as to extend in the Z-axis direction. As shown in FIGS. 6A and 6B, the light emitting section 74 has a light emitting body 75 and a transmission window 76.

The transmission window 76 is provided on the side surface of the +Y direction side of the outer member 72a and 72b and extends in the Z-axis direction. The transmission window 76 is formed of a semitransparent member capable of transmitting light. The transmission window 76 has an arc-shaped outer shape as viewed from the direction along the Z-axis direction. The transmission window 76 may be formed of a transparent or semitransparent resin material, and may be integrally formed with the outer members 72a and 72b, which are formed of a resin material, by injection molding.

The light emitting body 75 is provided in the support pillars 71a and 71b on the −Y direction side of the transmission window 76 provided in the outer members 72a and 72b. As the light emitting body 75, a rod-like light emitting body formed by arranging a plurality of light emitting diodes in the Z-axis direction can be employed. The light emitted from the light emitting body 75 can be visually checked from the +Y direction side of the recording device 11 through the transmission window 76. According to this, since the light emitting section 74 emits light, it is possible to notify at least a user who is on the +Y direction side of the recording device 11 of the state or the like of the recording device 11.

The emission color of the light emitting section 74 is not particularly limited but may be, for example, blue. Alternatively, the light emitting section 74 may have a function of switching the emission color. In this case, the light emitting section 74 may have, for example, a function of switching the emission color between blue and red. Note that the light emitting section 74 may not be provided on the support pillars 71a and 71b. For example, the light emitting section 74 may be provided on one of the support pillars 71a and 71b, for example, on the support pillar 71a.

The support pillars 71a, 71b, 71c, and 71d are provided with an illumination section 77 configured to illuminate the medium 18 placed on the placement tray 41. The illumination section 77 of the present embodiment is provided at a position closer to the placement tray 41 in the Z-axis direction than a lower surface which is a surface on the +Z direction side of the reading section 23. In the present embodiment, the illumination sections 77 provided on the support pillars 71a, 71b, 71c, and 71d have the same specification.

As shown in FIGS. 6A and 6C, the illumination section 77 is provided on the +X direction side surface of the support pillars 71a and 71c. As shown in FIGS. 6B and 6D, the illumination section 77 is provided on the −X direction side surfaces of the support pillars 71b and 71d. The illumination section 77 is provided at the same positions of the support pillars 71a, 71b, 71c, and 71d in the Z-axis direction.

As shown in FIG. 3, the illumination section 77 is provided at a position of the −X direction side of the support pillars 71b and 71d that is closer to the placement tray 41 and which is closer to the +Z direction side than the center in the Z-axis direction. Therefore, the illumination section 77 is provided at a position closer to the placement tray 41, which is closer to the +Z direction side than the center in the Z-axis direction, among the +X direction side of the support pillars 71a and 71c. The illumination section 77 has a light emitting body 78 and a transmission window 79.

The transmission window 79 is formed of a semitransparent member capable of transmitting light. The transmission window 79 may be formed of a transparent or semitransparent resin material, and may be integrally formed with the outer members 72a, 72b, 72c, and 72d, which are formed of a resin material, by injection molding.

The light emitting bodies 78 provided in the support pillars 71b and 71d are provided in the support pillars 71b and 71d on the +X direction side of the transmission windows 79 provided in the outer members 72b and 72d. The light emitting bodies 78 provided in the support pillars 71a and 71c are provided in the support pillars 71a and 71c on the −X direction side of the transmission windows 79 provided in the outer members 72a and 72c. The light emitting color of the light emitting body 78 is, for example, white.

As the light emitting body 78, a rod-like light emitting body formed by arranging a plurality of light emitting diodes in the Z-axis direction can be employed. The light emitted from the light emitting body 78 illuminates a region at the center in the X-axis direction of the upper surface of the device main body 12 including the placement tray 41 through the transmission window 79. As a result, the illumination section 77 can illuminate the medium 18 placed on the placement tray 41. Note that the illumination section 77 may not be provided on the support pillars 71a, 71b, 71c, and 71d. For example, the illumination section 77 may be provided on the support pillars 71a and 71b. Alternatively, the illumination section 77 may be provided on the support pillar 71a.

The control section 33 generally controls the driving of each mechanism in the recording device 11 and controls various operations executed in the recording device 11. The control section 33 may be configured as a circuit including one or more processors for executing various processes according to a computer program, one or more hardware circuits for executing at least a part of the various processes, or a combination thereof. The hardware circuit is, for example, an application-specific integrated circuit. The processor includes a CPU and memory, such as RAM and ROM, and the memory stores program code or instructions configured to cause the CPU to perform processes.

For example, the control section 33 controls the first feeding section 38, the transport section 39, the recording section 30, and the discharge section 31 to transport the medium 18 on which recording has been performed by the recording section 30 toward the placement tray 41. The control section 33 controls the second feeding section 64, the transport section 39, the recording section 30, and the discharge section 31 to transport the medium 18, on which recording has been performed by the recording section 30, toward the placement tray 41.

The control section 33 controls the document transport section 28 and the read sensor 24 to discharge the document, from which the image or the like has been read by the read sensor 24, to the document discharge tray 29. The control section 33 notifies the user of the state of the recording device 11 by controlling the notification section 22 to display a message on the monitor of the notification section 22.

The control section 33 illuminates the medium 18 placed on the placement tray 41 by controlling the light emission of the illumination section 77. The control section 33 notifies the user of the state of the recording device 11 by controlling the light emission of the light emitting section 74. For example, the control section 33 may notify that the amount of ink in the liquid accommodation body 17 is small by causing the light emitting section 74 to blink with a red light emission color. For example, the control section 33 may notify that there is no ink in the liquid accommodation body 17 by causing the light emitting section 74 to turn on with a red light emission color.

For example, the control section 33 may notify that recording on the medium 18 is being performed by the recording section 30 by moving the lighting position of a blue light emission color of the light emitting section 74. For example, the control section 33 may notify that the medium 18 on which recording has been performed by the recording section 30 is placed on the placement tray 41 by causing the light emitting section 74 to blink in a blue light emission color.

As described above, according to recording device 11 of the first embodiment, the following effects can be obtained.

The recording device 11 includes the device main body 12 having the placement tray 41 on which the medium 18 recorded by the recording section 30 is placed and the reading section 23 that is provided on the −Z direction side of the device main body 12 and that is configured to read the document. The recording device 11 includes the support section 70 that is provided between the device main body 12 and the reading section 23 in the Z-axis direction and that is configured to support the reading section 23. Also, the support section 70 includes the plurality of support pillars 71a and 71c provided on the outer side of the end of the placement tray 41 in the −X direction in the X-axis direction. The support section 70 includes a plurality of support pillars 71b and 71d provided on the outer side of the end of the placement tray 41 in the +X direction in the X-axis direction. According to this configuration, the medium 18 placed on the placement tray 41 is easily seen from the +X direction side, the −X direction side, and the −Y direction side of the recording device 11.

The medium 18 on which recording has been performed is placed on the placement tray 41 by being transported from the +Y direction side of the device main body 12 toward the placement tray 41. An outer side surface on the +Y direction side of the support pillar 71a, which is positioned closest to the +Y direction side among the plurality of support pillars 71a and 71c, which are provided on the outer side of the −X direction end of the placement tray 41, has the rounded outer shape as viewed from the direction along the Z-axis direction. An outer side surface on the +Y direction side of the support pillar 71b, which is positioned closest to the +Y direction side among the plurality of support pillars 71b and 71d, which are provided on the outer side of the +X direction end of the placement tray 41, has the rounded outer shape as viewed from the direction along the Z-axis direction. According to this configuration, the medium 18 placed on the placement tray 41 can be easily taken out from the placement tray 41. When the medium 18 is taken out from the placement tray 41, it is possible to suppress the occurrence of problems due to the user coming into contact with the support pillars 71a and 71b.

The support pillars 71a, 71b, 71c, and 71d of the support section 70 have the same thickness. According to this, it is easy to commonize the members constituting the support pillars 71a, 71b, 71c, and 71d. Therefore, it is easy to reduce the cost of recording device 11 and improve its ease of assembly.

The support pillars 71a, 71b, 71c, and 71d are white, and the placement tray 41 is black. According to this, the medium 18 placed on the placement tray 41 is easy to see.

The support pillars 71a and 71b are provided with the light emitting section 74 for notification by emitting light. According to this configuration, it is possible to notify the user of the state or the like of the recording device 11 by the light emitting section 74 emitting light.

The support pillars 71a, 71b, 71c, and 71d are provided with the illumination section 77 configured to illuminate the medium 18 placed on the placement tray 41. This makes it easy to see the medium 18 placed on the placement tray 41.

Although the recording device 11 according to the above embodiment of the present disclosure basically has the configuration as described above, it is of course possible to change or omit portions of the configuration within the scope not departing from the gist of the present disclosure. The above described embodiment and other embodiments to be described below can be implemented in combination with each other within a technically consistent range. Hereinafter, other embodiments will be described.

In the above described embodiment, the thicknesses of the support pillars 71a, 71b, 71c, and 71d may not be the same. For example, the thickness of the support pillars 71a, 71b, 71c, and 71d may be varied in accordance with the load of the reading section 23 applied to each of the support pillars 71a, 71b, 71c, and 71d. In the present embodiment, the support pillars 71b and 71d are closer in distance in the X-axis direction from the document transport section 28 than the support pillars 71a and 71c.

That is, the support pillars 71b and 71d, as compared with the support pillars 71a and 71c, are closer in the X-axis direction to the centroid of the reading section 23. In this case, for example, as shown in FIGS. 7A, 7B, 7C, and 7D, the thickness of the support pillars 71b and 71d may be increased compared to that of the support pillars 71a and 71c.

In this case, the outer dimensions of the outer members 72b and 72d in the X-axis direction may be made larger than the outer dimensions of the outer members 72a and 72c in the X-axis direction to increase the load capacity of the support pillars 71b and 71d. Alternatively, the thickness dimension of the outer members 72b and 72d may be made larger than the thickness dimension of the outer members 72a and 72c to increase the load capacity of the support pillars 71b and 71d.

Alternatively, the dimensions of the inner members 73b and 73d in the axial direction may be made larger than the dimensions of the inner members 73a and 73c in the X-axis direction to increase the load capacity of the support pillars 71b and 71d. Alternatively, the thickness dimension of the inner members 73b and 73d may be made larger than the thickness dimension of the inner members 73a and 73c to increase the load capacity of the support pillars 71b and 71d.

Alternatively, combining a plurality of dimensional changes of the above described outer members 72b, 72d and inner members 73b, 73d to increase the load capacity of the support pillars 71b and 71d. As described above, according to the recording device 11 of this embodiment, the following effects can be obtained.

Among the support pillars 71a, 71b, 71b and 71d included in the support section 70, the support pillars 71b and 71d close to the centroid of the reading section 23 are thicker than support pillars 71a and 71c remote from the centroid than the support pillars 71b and 71d close to the centroid. According to this, the reading section 23 is more stably supported by the support section 70.

The reading section 23 includes the document transport section 28 configured to transport the document. The support pillars 71b and 71d close to the document transport section 28 are thicker than the support pillars 71a and 71c remote from the document transport section 28 than the support pillars 71b and 71d close to the document transport section 28. According to this, the reading section 23 is more stably supported by the support section 70.

The outer dimensions of support pillars 71b and 71d in the X-axis direction are larger than the outer dimensions of support pillars 71a and 71c in the X-axis direction, and the outer dimensions of support pillars 71a, 71b, 71c, and 71d in the Y-axis direction are the same. According to this configuration, stable support of the reading section 23 by the support section 70 can be realized while maintaining visibility of the medium 18 placed on the placement tray 41 from the +X direction side.

In the embodiment described above, the light emitting section 74 may be provided on any of the side surfaces other than the side surfaces on the +Y direction side of the support pillars 71a, 71b, 71c, and 71d. For example, as shown in FIG. 7A, the light emitting section 74 may be provided on the side surface of the-X direction side of the support pillar 71a. Accordingly, the visibility of the light emitting section 74 for the user on the-X direction side of the recording device 11 may be improved. For example, as shown in FIGS. 7C and 7D, the light emitting section 74 may be provided on the side surface of the −Y direction side of the support pillars 71c and 71d. Accordingly, the visibility of the light emitting section 74 for the user on the −Y direction side of the recording device 11 may be improved.

In the above described embodiment, the light emitting section 74 may not be provided on the side surfaces of the support pillars 71a and 71b on the +Y direction side so as to extend in the Z-axis direction. For example, the light emitting section 74 may be provided so as to extend in the horizontal direction over a plurality of side surfaces of the support pillars 71a and 71b. In this case, as viewed from the direction along the Z-axis direction, the cross-section of the transmission window 76 may have the same annular shape as the cross sections of the outer members 72a and 72b. In this case, an annular light emitting body formed by annularly arranging a plurality of light emitting diodes can be adopted as the light emitting body 75 provided in the support pillars 71a and 71b.

In the above embodiment, the light emitting section 74 may be omitted. In this case, the control section 33 may notify the user of the state of the recording device 11 by controlling the light emission of the illumination section 77.

In the above embodiment, the illumination section 77 may be omitted.

In the above embodiment, the outer members 72a, 72b, 72c, and 72d may not necessarily be white. For example, the outer members 72a, 72b, 72c, and 72d may be black. In this case, the support pillars 71a, 71b, 71c, and 71d are black.

In the above embodiment, the support pillars 71a and 71b may not be provided on the −Y direction side with respect to the +Y direction end of the recess 42. For example, the support pillars 71a and 71b may be provided on the −Y direction side with respect to the end of the recess 42 in the −Y direction.

In the above embodiment, the dimension of the interval in the Y-axis direction between the support pillar 71a and the support pillar 71c may be equal to or larger than the dimension in the discharge direction of the medium 18 discharged to the placement tray 41. The dimension in the Y-axis direction of the interval between the support pillar 71b and the support pillar 71d may be equal to or larger than the dimension in the discharge direction of the medium 18 discharged to the placement tray 41. In this case, the support pillars 71a and 71b may not be provided on the −Y direction side with respect to the +Y direction end of the placement tray 41. For example, the support pillars 71a and 71b may be provided among the upper surface of the device main body 12 at a position in the +Y direction side from the +Y direction end of the placement tray 41. In this case, the user can take out the medium 18 placed on the placement tray 41 through the interval between the support pillar 71a and the support pillar 71c or the interval between the support pillar 71b and the support pillar 71d.

What is claimed is:

1. A recording device comprising:
a device main body having a placement tray on which a medium recorded by a recording section is placed;
a reading section that is provided upward from the device main body and that is configured to read a document; and
a support section that is provided between the device main body and the reading section in a height direction of the device main body and that is configured to support the reading section, wherein
the support section includes
a plurality of support pillars provided on an outer side of one end of the placement tray in the width direction of the device main body and
a plurality of support pillars provided on an outer side of an other end of the placement tray in the width direction.

2. The recording device according to claim 1, wherein
the medium on which recording has been performed is placed on the placement tray by being transported from the front surface side of the device main body toward the placement tray,
an outer side surface on the front surface side of the support pillar positioned closest to the front surface side among the plurality of support pillars provided outside the one end of the placement tray has a rounded outer shape as viewed from the direction along the height direction, and
an outer side surface on the front surface side of the support pillar positioned closest to the front surface side among the plurality of support pillars provided outside the other end of the placement tray has a rounded outer shape as viewed from the direction along the height direction.

3. The recording device according to claim 1, wherein
the support pillars of the support section have the same thickness.

4. The recording device according to claim 1, wherein
among the support pillars included in the support section, a support pillar close to the centroid of the reading section is thicker than the support pillar remote from the centroid than the support pillar close to the centroid.

5. The recording device according to claim 4, wherein
the reading section includes a document transport section configured to transport the document and
the support pillar close to the document transport section is thicker than the support pillar remote from the document transport section than the support pillar close to the document transport section.

6. The recording device according to claim 1, wherein
the plurality of support pillars provided on the outer side of the one end of the placement tray are constituted by two support pillars and the plurality of support pillars provided on the outer side of the other end of the placement tray are constituted by two support pillars.

7. The recording device according to claim 1, wherein
the support pillars are white, and the placement tray is black.

8. The recording device according to claim 1, wherein
the support pillar is provided with a light emitting section for performing notification by emitting light.

9. The recording device according to claim 1, wherein
the support pillar is provided with an illumination section configured to illuminate the medium placed on the placement tray.
